(19) United States
(12) Patent Application Publication
(10) Pub. No.: US 2025/0166617 A1
(43) Pub. Date: May 22, 2025

(54) SYSTEM AND METHOD FOR COMPUTER PREDICTION USING VOICE AND SOUND

(71) Applicant: Surgical Safety Technologies Inc., New York, NY (US)

(72) Inventors: Filip GRANTCHAROV, Toronto (CA); Peter Dupont GRANTCHAROV, Toronto (CA); Po-Chieh LIU, Toronto (CA); Kee TANG, Toronto (CA); Amar S. CHAUDHRY, Toronto (CA); Zhifeng ZHANG, New York, NY (US)

(21) Appl. No.: 18/954,493

(22) Filed: Nov. 20, 2024

Related U.S. Application Data
(60) Provisional application No. 63/600,868, filed on Nov. 20, 2023.

(51) Int. Cl. G10L 15/16; G10L 15/30; G10L 25/57; H04N 19/103; H04N 19/136

(52) U.S. Cl. CPC G10L 15/16; G10L 15/30; G10L 25/57; H04N 19/103; H04N 19/136

(57) ABSTRACT

A local machine learning based recording and audio transcribing system is proposed that operates in real-time in parallel and time-synchronized with a operating theatre recorder system, modifying encoding of the operating theatre recorder system outputs for generation of the pre-processed recording files to be transmitted to a remote cloud-based processing backend using operating a centralized machine learning model data architecture across a network. By modifying the recording or the generation of the pre-processed recording files, the system can be tuned for providing increased signal resolution at more relevant portions of time or frame portions to improve the accuracy and predictive capability of a backend machine learning model that is configured for operation using the pre-processed recording files while adapting for practical network bandwidth and computing resource limitations in cloud-based implementations.

### CROSS REFERENCE

This application is a non-provisional of, and claims all benefit to, including priority from, Application No. 63/600,868, filed 2023 Nov. 20, entitled SYSTEM AND METHOD FOR COMPUTER PREDICTION USING VOICE AND SOUND. This document is incorporated herein by reference in its entirety.

### FIELD

Embodiments of the present disclosure relate to the field of machine learning and applied machine audio transcription, and more specifically, embodiments relate to devices, systems and methods for improved computer predictions using voice or sound using machine learning by using transcription outputs to modify operational and pre-processing parameters for encoding local recordings for transmission to remote backend processing using artificial intelligence/machine learning models.

### INTRODUCTION

A challenge with hospital/operating theatres and facilities is that while recordings can be made, they are often low quality and interspersed with noise artifacts and other sounds.

This is further complicated by a lack of consistency as different facilities are equipped with different equipment from different manufacturers, and the data that is tracked is often unstructured unlabelled data.

While unstructured audio recordings may be made and transcribed, but on their own, may be of limited utility to analysis given the volume of proceedings and a difficulty in identifying useful sections or components of the unstructured audio recordings or transcripts.

Currently, medical practitioners record a short summary from their recollection after a procedure is completed, but a challenge with these summaries is that they are limited by the practitioner's memory and may not capture the full extent of activities during a procedure. Finally, the post-procedure summary does not have adequate time-stamps and may not accurately reflect the order in which steps were taken, especially after a very long and complicated procedure. Accordingly, even a transcript of the post-procedure summary is limited in its ability to be consumed by a machine learning model for improved predictions.

### SUMMARY

Operating room audio is a useful source of unstructured data, and a technical approach is proposed to practically utilize the unstructured data from audio data resources for practical machine learning implementations that can be used, for example, to increase operational efficiency for hospitals, documentation, and ultimately drive improved patient outcomes. An improved system is described in various embodiments that is adapted for recording and transcribing audio in combination with specially configured recording devices and corresponding orchestration hardware/software that is coupled to the specially configured recording devices, wherein the recorded and transcribed audio can be used, among others, to provide real-time decision support by modifying one or more technical characteristics of the specially configured recording devices or backend processing, generate improved post-operative documentation, and automate billing considerations. The features can also be used to modify a post-operative plan based on tracked artifacts present in a generated transcription data object.

The recording and audio transcribing system operates in real-time in parallel and time-synchronized with an operating theatre recorder system, and is used to modify operation of the operating theatre recorder system during recording, and/or during generation of the pre-processed recording files to be transmitted to a cloud-based processing backend across a network before deletion of the raw recording files (due to storage or network limitations).

By modifying the recording or the generation of the pre-processed recording files, the system can be tuned for providing increased signal resolution at more relevant portions of time, at more relevant frequencies, or at more relevant visual bounding boxes of the recording to improve the accuracy and predictive capability of a backend machine learning model that is configured for operation using the pre-processed recording files.

In particular, audio transcription are proposed and adapted for use to transcribe the audio from captured case recordings. Transcription machine learning model data architectures are used to produce a transcript, and different models can be substituted or utilized. The transcription is generated in real or near real time in parallel with recording devices of an operating room “black box”.

The approaches proposed herein are particularly useful where practitioners are trained to use “closed loop” communication protocols where the practitioners try to verbalize the steps that they are taking, and the support staff try to verbally acknowledge every communication. Accordingly, a rich transcript of verbalized activities is possible.

A proposed workflow is described that where firstly, operating room audio is captured using one or more microphones, secondly audio processing is conducted for, for example, background noise reduction, alarm elimination, etc.). Once processed audio is prepared, it can be used for transcription inference, where the input audio data is converted into textual data. Specific use-case based models are then utilized for generating use-case dependent output, which can include specific data structures such as timestamps, summary data, etc. Effectively, audio is captured for every case, and potentially provided into a distributed cloud based computing resource that is adapted to transcribe the audio into text based transcripts. The transcription can be conducted, for example, using a separate audio analysis model data architecture that may be operating on separate computing infrastructure. In some embodiments, a separate computing infrastructure is also being utilized to monitor a physical premises continually to determine whether the physical premises is being occupied for usage, and that separate computing infrastructure runs a parallel model for voice transcription.

The proposed approach is directed to converting raw audio data into meaningful insights. The different use cases can include, for example, surgical safety checklist timing prediction, additional time-stamping (e.g., start of intubation, time of blood transfusion), case summary notes (which could then be directly inserted into the EMR (i.e., “3 blood transfusions, surgeon indicated to keep in ICU 5 days, etc.), and speech initiated commands that are triggered based on defined specific audio commands that result in downstream action (e.g., “BLACK BOX . . . FLAG this case”, “BLACK BOX . . . CLIP the next 30 seconds in Explorer”).

The voice is transcribed and timestamped such that the timestamped voice transcription can be converted into particular actions or time-stamped voice or sound events that represent specific events taking place. These can include a healthcare practitioner's voice instructing modifying characteristics of the recording, or dictating for the record the practitioner's perspective or observation of activities taking place before, during, or after a procedure. Before a procedure, the healthcare practitioner may be providing voice commentary or deliberately indicating that certain checklist items are being taken care of in preparation, during a procedure, the healthcare practitioner may be stating observations or steps of the procedure (or if complications are arising), and after a procedure, the healthcare practitioner may be dictating voice notes for inclusion into a final record of the procedure. The voice commentary can be coupled with background sound, including device and machinery sounds, which can also be converted into specific artifacts, which can be used for correlation and analysis. These can include the sound of devices being attached, activated, detached, activated, among others.

For example, in respect to checklists, there exists a collection of words relatively unique to when the checklists take place (e.g., “Timeout”, “Briefing”, etc.), and initial results suggest that these relationships are well within the limitations of RNN-based architectures. For the checklist example embodiment, the events being taken place may also be correlated with tracked sounds that should also be indicative of events taking place. For example, in a hand washing example, there may be trackable sound artifacts of the faucet being activated, the soap dispenser being activated, among others. All of these may be used by the backend machine learning model engine to modify characteristics of the capture to obtain a higher resolution capture, for example, increasing recording resources immediately after the healthcare practitioner indicates that the washing hands process is beginning so that the faucet and soap dispenser activation can be tracked. An increased resolution of machine learning can therefore taken place with additional dimensions being tracked, albeit at a higher computing and networking resources cost.

In some embodiments, the recording devices capture locally the recordings at a high resolution/fidelity, but networking and storage limitations limit what can be transmitted to a remote centralized machine learning controller server that services all of the connected operating rooms. In this example, the transcriptions are used instead to modify how encoding is performed locally before transmission to the remote centralized machine learning controller server to selectively preserve fidelity of the original high resolution recording using variable compression approaches across different time durations or different snippet portions (or both at once) of high resolution recorded video. The variable compression, as it relates to audio, can also be selective for particular frequency bands, such as applying a bandpass filter to allow compression of non-relevant bands but maintaining high fidelity in a particular band.

From a practical perspective, these features can be utilized to generate a data output representative of how well the machine learning model predicts that the healthcare practitioner followed or adhered to the steps of the required checklist, such as every step of the handwashing process, including faucet and soap dispenser activation.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an illustration of a system for computer prediction using voice and sound, according to some embodiments.

FIG. 2 is a process diagram showing an example method for computer prediction using voice and sound, according to some embodiments.

FIG. 3 is a process diagram showing an example method for use-case specific transcript/audio processing for checklist timing prediction, according to some embodiments.

FIG. 4 is a process diagram showing an example method for use-case specific transcript/audio processing for enhanced time-stamp generation, according to some embodiments.

FIG. 5 is a process diagram showing an example method for use-case specific transcript/audio processing for case summary additions, according to some embodiments.

FIG. 6 is a process diagram showing an example method for use-case specific transcript/audio processing for speech initiated commands, according to some embodiments.

FIG. 7 provides an example pipeline flow for a practical applied implementation for an example hospital network having multiple hospital sites each having multiple operating rooms that are coupled to one or more instances of cloud based black box recorder controllers that are adapted to receive pre-processed recordings and generate machine learning predictive outputs by processing the pre-processed recordings along with other input signals against trained models, according to some embodiments.

FIG. 8 is an illustration showing a pictorial representation of the pre-processing instructions to be applied to the full resolution local recording, according to some embodiments.

### DETAILED DESCRIPTION

Operating room audio is a useful source of unstructured data, and a technical approach is proposed to practically utilize the unstructured data from audio data resources for practical machine learning implementations that can be used, for example, to increase operational efficiency for hospitals, documentation, and ultimately drive improved patient outcomes.

An improved system is described in various embodiments that is adapted for recording and transcribing audio in combination with specially configured recording devices and corresponding orchestration hardware/software that is coupled to the specially configured recording devices, wherein the recorded and transcribed audio can be used, among others, to provide real-time decision support by modifying one or more technical characteristics of the specially configured recording devices or backend processing, generate improved post-operative documentation, and automate billing considerations. The features can also be used to modify a post-operative plan based on tracked artifacts present in a generated transcription data object.

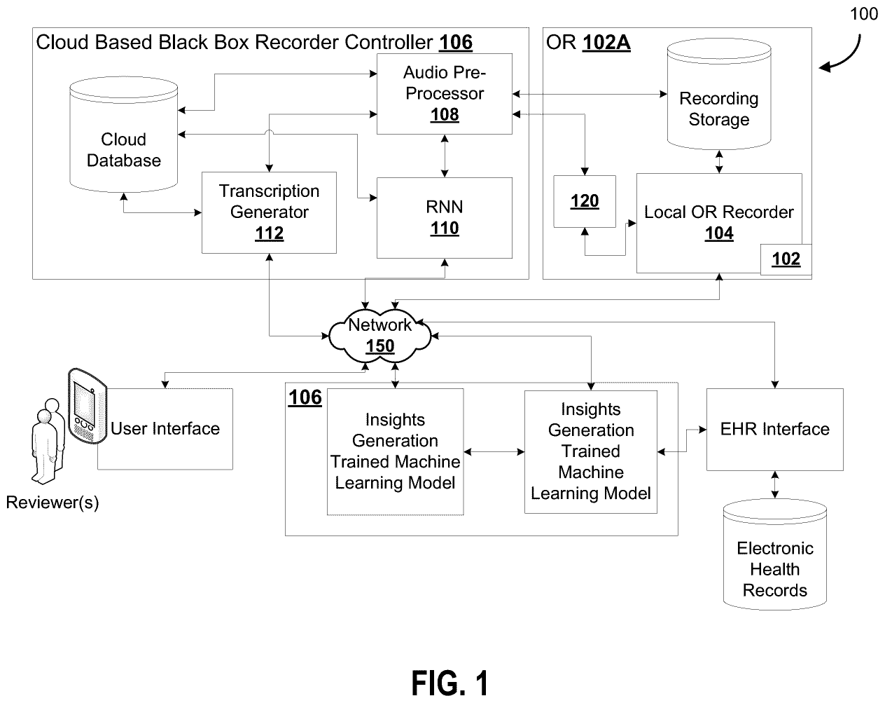

FIG. 1 is an illustration of a system for computer prediction using voice and sound, according to some embodiments. The system is configured generating timestamped transcriptions using a local audio machine learning model data architecture to control compression parameters for converting local video recording data captured in an operating room or therapeutic facility.

The encoding occurs prior to transmission to a remote machine learning controller, which is configured to process the converted recording data using a trained machine learning model data architecture. The encoding is designed to compress the local recording (which can have a very large file size) to generate an encoded compressed version that can be viably transmitted across a network and provided to the remote machine learning controller so that the remote machine learning controller can utilize global hospital group or hospital site level trained machine learning model data architectures for insight or prediction generation.

The captured local sound and audio can be captured on a dedicated local stack for transcription, the transcription capturing discussions between practitioners or vocal instructions or commentary by a practitioner. This is particularly useful as many medical operations utilize “closed loop” discussion protocols, where the practitioners are trained or instructed to vocalize, as much as possible, the steps or activities being taken or aspects taking place as part of a procedure.

The proposed approach proposed herein utilizes the local transcription model to use the “closed loop” discussion commentary, timestamps the generated transcription tokens, clusters the tokens to map timestamp durations to specific steps of a checklist or when inventory items/surgical procedure commentary was described, and then modifies how encoding is conducted on local recordings in an effort to selectively maintain fidelity from the local video recording data despite required compression before practical transmission to the remote machine learning controller. The selectively maintained fidelity allows increased (or in some embodiments, full resolution) recording data to be provided to the remote machine learning controller so that the machine learning controller can benefit from as much fidelity in the recorded audio or video information as possible when conducting machine learning at a centralized level.

The local transcription model is local to the operating room, for example, and can be a separate computing stack that is being utilized for other purposes, such as tracking room state usage, room utilization, among others.

In FIG. 1, the system 100 includes an operating room 102A that is equipped or retrofitted with microphones 102 that can be coupled to a local black box recorder device 104 and/or a cloud-based black box recorder controller 106. Case recordings are generated by the microphones 102, and the case recordings can include audio and/or sound recordings at various durations of time. A subset or all of the microphones 102 are further coupled to an audio transcription engine 120, which is configured, in some embodiments, as a lower power room state monitoring device that is configured to record a periodic or continuous audio track in the operating room 102A that is used for room state analysis.

The audio transcription engine 120 operates locally at the operating room 102A and can be physically implemented as a specialized server with dedicated transcription hardware, that has a local implementation of a trained machine learning model (e.g., the Whisper model as described further in an example non-limiting embodiment). The trained model is used to generate a continuous stream of transcription tokens, for example, in a real-time or in a near-real time basis based on a recording snippet (every minute, every 5 minutes). In some embodiments, the trained model of the audio transcription engine 120 can also be configured to track certain types of machine outputs or sounds, such as the sound of a faucet being activated, the sound of a machine being turned on, indicative of correct operation (e.g., vacuum sound of a pressurization), and in some embodiments, abnormal operation of the machine (e.g., leaking sound during a failed pressurization, possibly due to a failed gasket). The audio outputs can include specific tokens, for example, representing different words spoken by different individuals in the operating room 102A.

In the specific example described herein, the recordings are raw .WAV file type recordings of the room audio, and these can be an audio bitstream that stores a waveform audio recorded, for example, from t=0 to t=300 s, and so on. The practitioner states “Black Box, I am starting the surgical hand rubbing technique, please begin the checklist”. As the practitioner undertakes the various steps, the practitioner is having a conversation with support members of the team, asking them to provide various materials, and the practitioner and the support members may also be operating various devices, such as faucets, soap dispensers. The steps may take a period of time to occur.

During the hand rubbing process, the practitioner is following steps of a surgical checklist, and vocalizing the various steps taking place. These steps can include specific steps of pumping an alcohol based hand rub product, using an elbow to operate a dispenser, decontaminating nails, smearing the handrub up a forearm to cover the whole skin area, repeating the steps for the other arm, rubbing the hands at the same time, covering the front of the hands, the back of the hands, the fingers, the palms, and then finally donning sterile surgical clothing and gloves. As shown in this example, there are many detailed steps and automatically determining the quality of adherence to the checklist can be difficult. Even missing what appears to be a small step, such as decontaminating an “under the nails” region could lead to post-operative complications or infection.

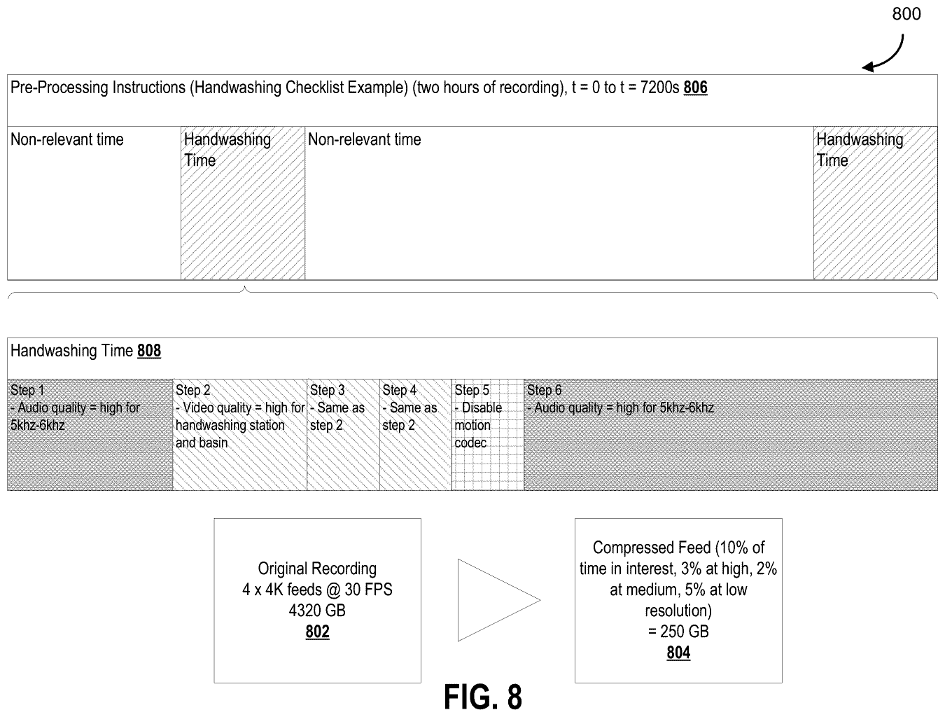

The transcription tokens of specific words being said are used for mapping specific durations of time to specific steps. The mapping can be conducted, for example, based on machine classification conducted by the local transcription model by mapping specific words or specific durations of time using a fuzzy matching or machine learning based clustering approach. For example, specific words or steps being taken may be used to trigger a step change, and the local system can be configured to use these specific words to establish that a timestamped duration is associated with a particular step. In another variation, approximate string matching (e.g., fuzzy matching) is used instead, based on a determined closeness or similarity of the words being utilized based, for example, on an edit distance between the spoken transcribed tokens and a string pattern associated with a particular step. The specific words can be clustered together so that ultimately, each step of a checklist or a process being taken is assigned a timestamp duration (and potentially a confidence score). An example for handwashing is shown in more detail at FIG. 8. The transcribed words can be analyzed using cluster analysis and the edit distance if explicit steps or words are not specifically utilized by the practitioner.

In some embodiments, the data structure and the steps for clustering are known in advance, and can be selected from a set of reference templates. Steps may also occur out of order, in some embodiments.

In other embodiments, the data structure is generated based on the transcription tokens. This embodiment occurs, for example, in use cases where the items/steps are not known a priori, and must be first extracted from the transcription tokens, such as when the transcription is being used for instrument usage detection or procedure step detection. In this example, the practitioner says “no. 3 scalpel”, then “size 5 gauze sponge”, and then “brand A liquid stitches”.

Each of these are inserted as rows in the data structure, and then the clustering and classification occurs to identify the transcription word/phrase tokens that were related to each of these items for the purposes of assigning a central timestamp for when each of these instruments were used (e.g., no. 3 scalpel was used at t=2436 ms, size 5 gauze sponge was used at t=3201 ms). Each inventory item being used is a new data row having corresponding data fields to be filled in based on the timestamped transcription tokens. In this example, the recording encoding instructions could then ensure that there is high resolution recording of the instrument tray bounding box region from t=2400 to t=2600 ms, for example, so that the remote machine learning model can be utilized with a high fidelity input to then later generate a machine learning based prediction output of whether the no. 3 scalpel as actually taken off the instrument tray and used based on an analysis of the video.

By maintaining fidelity of that portion of the video for that duration, inadvertent loss of relevant information through compression can be avoided by selectively modifying compression just for that duration and that segment. A similar approach can be taken for specific surgical activities where they are not planned or not part of a specific checklist. For example, the local transcription model may be used to determine when additional tasks were done for the purposes of accurate tracking for record keeping or billing, such as opportunistic tissue repairs done by the practitioner during an exploratory phase of surgery.

The audio transcription engine 120 is time-synchronized to local OR recorder 104, for example, based on synchronizing clocks together periodically to account for time-drift. Synchronization is very important as the outputs from the audio transcription engine 120 will be applied to modify how the pre-processor 108 will instruct what data will be transmitted from the local recording at 102A across the network to the cloud based black box recorder controller 106 for downstream analysis and insight generation using machine learning models. In a variant embodiment, the pre-processor 108, instead of being on the cloud-side, is instead residing locally at the OR 102A side.

Time-stamped tokens are generated, and each of the words of the practitioner and the practitioner's support staff are captured and transcribed from the local waveform file. The transcription is a compressed version of the local waveform file, and in some embodiments, the transcription is also provided as a data object to the cloud based black box recorder controller 106 to assist as an additional machine learning input signal for downstream analysis and insight generation.

The time-stamped tokens, when taken together, can be grouped based on specific durations of time when different activities are being performed. In an example surgical procedure, these can include pre-surgery checklists (e.g., hand washing, instrument preparation, anaesthetic delivery, cleaning of the surgical site), planned surgical activities (e.g., abdominal incision, tying off the appendix with stitches, determining the status of the appendix, removal of the appendix, closing of the abdomen), unplanned surgical activities (e.g., cleaning the abdomen after appendix removal if the appendix has burst or ruptured) and post-surgery activities (e.g., preparing a post-operative voice recording summarizing the procedure). In the example above, the transcription tokens can be clustered by a clustering engine to automatically assign periods of time to different activities, and then each step of a particular activity or checklist type.

As described herein, the local transcription tokens and the clustered determinations are then utilized to modify the local recording and pipeline before transmission to the cloud-based black box recorder controller 106 to assist in conserving limited computing processing resources, storage resources, as well as network transmission resources as surgical recordings have large file sizes and require compression prior to transmission to avoid overwhelming the finite computing resources. The modified local recording, as described in embodiments herein, are used to generate a modified instruction set for local pre-processing prior to transmission, the modified instruction set based on time-stamped durations of time from the transcription to modify when and how the pre-processing should occur. This allows for increased recording fidelity and reduced compression loss during particularly important durations of time as indicated in a timeline based on the transcription tokens. The increased fidelity and reduced compression loss allows for improved machine learning accuracy and resolution during the relevant times of interest as indicated by a locally generated surgical timeline having timestamped sections for improved recording.

A simplified illustrative example can use recording/compression bitrate. The local recording may be initially recorded with a lossless audio format (e.g., FLAC) and a high resolution video (e.g., a 4K video), along with a high resolution machine output signal. However, the local recording has very high storage requirements and would otherwise take a long time to transmit to the cloud-based black box recorder controller 106 across the hospital network for processing using a trained machine learning model that is operating using cloud based resources by the cloud-based black box recorder controller 106.

Accordingly, the local recording requires compression and potential trimming before transmission across the local hospital network. It is important to note that in a hospital environment, there can be a large number (e.g., 50-100) operating rooms that are coupled to cloud-based black box recorder controller 106, and in some embodiments, multiple hospital sites in a coupled hospital network may share a cloud-based black box recorder controller 106 that is operating at a remote data center (or is provided using a combination of cloud-based resources), and thus networking resources must be shared across all of the sites. Using a centralized cloud-based black box recorder controller 106 across one or more hospital sites allows for supercomputer level analysis (e.g., processing using a high-dimensionality model on a combined set of high-performance graphical processing units (GPUs) and a coordination of shared resources based on a high level of dimensionality, as well as tracked external factors and input signals, such as practitioner years of experience, profile, patient profile/electronic medical records, among others that are available to the cloud-based black box recorder controller 106 as additional signals for analysis.

The centralized cloud-based black box recorder controller 106 receives, from the local OR recorder 104, a pre-processed version of the recording that has been compressed and reduced in size to allow for conservation of network, storage, and computing resources. For example, the pre-processed version can be assigned a default audio bitrate of 32 kb/s mp3 along with mp4 video at a high compression factor at 480p. This default recording parameters cause significant data loss. As described in example embodiments, the local transcription engine 102 generates the transcription timeline to identify specific durations of time that may be associated with various tasks, and during these specific durations of time, time-stamped metadata processing instructions are generated to modify the pre-processing steps used for the corresponding time-stamped durations of the local recording.

Effectively, the end result is that the encoded recording for the purposes of centralized machine learning that is transmitted to the remote system is generated using variable compression approaches, such as having variable bitrates or variable resolutions for particular portions, or compressed using different codecs and parameters in an effort to maintain sufficient fidelity for the specific portion to avoid loss of information. As different steps or activities being tracked have different informational requirements for the purposes of machine learning, the approach described herein utilizes the transcription as a mechanism to automatically selectively control how the encoding is done. Accordingly, the practitioner's voice commands, in the form of transcription tokens, is transformed into encoding parameters that are associated with specific durations of time, and the variable encoding helps preserve the analytical capabilities of the remote machine learning model despite the need for compression for viable transmission in a multiple operating room computing architecture where the remote machine learning model and corresponding controller devices serve multiple operating rooms that are coupled together via a network backbone or infrastructure.

As noted earlier, the transcription can include specific instructions to improve recording during periods of time as explicitly instructed by the practitioner (e.g., “Black Box, please record the next 60 seconds more intensively), or based on time periods automatically determined by the transcription timeline by the local transcription engine 102. This can include periods of time that are segmented based on performance of checklist steps as described above in relation to different steps of pre-surgical, surgical, and post-surgical procedures.

A pre-processing instruction set can be generated, for example, as a JSON or a XML data object, and this is utilized by the local OR recorder 104 to generate a modified recording that is to be transmitted across a network to the cloud-based black box recorder controller 106. The JSON or XML data object can include structured metadata, and can include pre-processing instructions.

In some embodiments, the pre-processing instructions can include quantized recording instructions that correspond to specific compression/processing parameters, such as “low, medium, or high” fidelity.

In another variant embodiment, instead, the pre-processing instructions include more specific and fine-tuned control of specific compression/processing parameters, such as recognizing that a particular step requires improved audio, or improved video, etc. In this fine-tuned example, during a pre-surgical handwashing checklist, audio recording resolution is increased to listen for scrubbing/faucet activation/soap dispenser sounds, and video pixels in a region corresponding to the faucet/soap dispenser/hands are increased in resolution and reduced compression is used.

This allows for more accuracy for the machine learning model to generate improved confidence scores relating to how well the hand washing/scrubbing was performed, which may require a very high level of audio resolution (as the sound of the scrubbing could be faint and needs to be distinguished from the sound of running water from the faucet-overly aggressive compression could inadvertently remove this level of analytical resolution).

During time-stamped durations corresponding to the surgery steps, the video pixels corresponding to the surgical field are to be transmitted with a low or no level of compression so that the downstream machine learning steps taken by cloud-based black box recorder controller 106 for analyzing the quality or activities taken during surgery can be improved. However, in this example, during the surgery steps, a high level of compression of the audio may be appropriate as the audio for these example surgery steps may not be particularly informative and thus not a particularly useful signal for the machine learning steps associated with the surgery steps.

In some embodiments, the audio transcription engine 120 operates separate from the cloud-based black box recorder controller 106 and is run as a dedicated operating process that operates continuously to support the room state monitoring determination engine, which is used to dynamically generate schedules for utilizing operating room 102A. In some embodiments, the audio transcription engine is coupled to the cloud-based black box recorder controller 106 for generating control signals to modify aspects of the operation of the recording devices, storage, or processing devices of the cloud-based black box recorder controller 106 in accordance with generated key phrases or signals captured during by the audio transcription engine. For example, black box control commands can be preceded with a initial initialization phrase, such as “Black Box [ . . . ]”, followed by verbal commands by the practitioner.

In a variant, the audio transcription engine 120 can generate a plurality of different transcripts and timelines, for different applied use cases, and these are generated locally sequentially or in parallel from the same waveform files. The plurality of different local timelines can then be used to generate a plurality of different pre-processing instructions, which can be used to generate a plurality of different pre-processed recordings for transmission to the cloud-based black box recorder controller 106. For example, there can be a first transcript data object relating to checklists, a second transcript data object relating to instrument usage, and a third transcript data object relating to surgical complications. In this variation, each of the different pre-processing instructions can be sequentially processed by the local OR recorder 104 to generate a plurality of different compressed recording versions for ultimately provisioning to the cloud-based black box recorder controller 106.

Once these different compressed recording versions are generated, the local OR recorder 104 can be configured to mark the full size recording to be safely discarded in conjunction with a local retention schedule (e.g., marked for local storage into lower cost slower archive storage to be deleted on a 30 day retention cycle). In some embodiments, the different compressed recording versions can be generated on a staggered cycle to provide an additional approach for conserving resources. For example, the first transcript data object relating to checklists can be processed first and used to generate an immediate/near-real time instruction set and compressed recording version for transmission first to the cloud-based black box recorder controller 106.

This is because the checklist adherence may be used to generate immediate alerts or modify a post-operative plan for the patient if certain steps were not adhered to (e.g., surgeon missed a step), poorly adhered to (e.g., surgeon washed hands too quickly), or the machine learning model was not able to conclusively reach a high confidence determination (e.g., surgeon's gown obstructed a view of the hands being washed). There could be a potentially higher chance for infection and the machine learning predictive outputs may be more time-sensitive.

On the other hand, the second transcript data object relating to instrument usage may be used for tracking/estimating inventory for inventory re-ordering or insurance tracking purposes, and the corresponding compressed recording version can be generated for transmission at a later time to the cloud-based black box recorder controller 106 as there is less time sensitivity.

In some embodiments, the generation of this corresponding compressed recording version can be conducted at a reduced traffic/improved computing availability time, such as being generated opportunistically when the operating room 102A is not scheduled in use or being prepared for another surgical procedure. Accordingly, the first compressed recording version (for the surgical checklist) may be prioritized for generation and transmission to the cloud-based black box recorder controller 106 over the second compressed recording version (for the instrument usage).

Even though there are potentially a plurality of different compressed recording versions being generated and ultimately transmitted to cloud-based black box recorder controller 106, there can still be significant computing and networking resource savings as the compression benefits can be significant. For example, different time durations are being emphasized in different compressed recording versions, and these time durations may only represent 1-10% of the total time being recorded. Even if 3 different streams are generated from the various local transcripts that were generated from the same video by 102, these together, even at 10% each being identified as recording at high quality, a compression ratio of >70% can still be achieved, providing significant computing resource and networking resource savings by the overall architecture.

As described herein, these verbal commands can include the practitioner giving instructions to modify operational aspects of the cloud-based black box recorder controller 106, and these instructions can include requesting the cloud-based black box recorder controller 106 to more intensively record during particular portions of the surgical procedure, to record the steps being taken corresponding to a particular surgical checklist or practice protocol, as well as verbal instructions to insert phrases into an electronic medical record.

The verbal commands are transcribed and generated from stored waveforms of the audio, and in some embodiments, the microphones 102 operating to capture this transcribed audio are generated on a separated computing system so that dedicated resources can be used to capture the transcribed audio. A transcription data object can be generated in real-time or near-real time in parallel with the generated recordings to be processed by cloud-based black box recorder controller 106.

The increased intensity of recordation can include increasing a bitrate of a recording, modifying a compression codec (e.g., to use a codec that operates faster but has a lower rate of compression or less loss), assigning more bandwidth resources to provide a better output to cloud-based black box recorder controller 106, or having cloud-based black box recorder controller 106 assign increased computing resources for the post-processing of the corresponding time-stamped durations of more intensive recording, allowing for a greater resolution of identified artifacts.

Following a procedure in operating room 102A, the recording files may be persisted for a time for post-analysis using instructions obtained from the transcribed audio, and in some embodiments, the transcribed audio is used to generate a time-stamped processing instruction set to be executed by the cloud-based black box recorder controller 106 in accordance with the instructions extracted from the transcribed audio before the cloud-based black box recorder controller 106 ultimately instructs for the deletion and removal of the stored recordings (e.g., to reduce overall physical computing storage required as the black box recordings may be very large) The time-stamped processing instruction set can include obtaining additional computing resources to process particular timestamp durations at a higher resolution to improve overall machine learning predictive performance during those particular timestamp durations.

An example time-stamped duration can include when a practitioner has orally noted that the practitioner is going to initiate actions in accordance with a checklist, and one or more time-stamped sub-durations are possible where action steps in accordance with the checklist are taking place.

During these time-stamped sub-durations, machine sounds and video of the operation can also be recorded by the cloud-based black box recorder controller 106 to predict whether the steps have taken place and the quality of the steps. For example, if a practitioner is taking steps in accordance with a hand-washing checklist, during the sub-durations corresponding to when the faucet was turned on, when the soap dispenser was activated, the recording generated by the black box recorders and analyzed by the cloud-based black box recorder controller 106 can be parsed to determine whether these steps took place.

The oral instructions generated by the practitioner can be similar to those provided at a teaching hospital, where the practitioner is talking through what they are doing, what instrument is being used, among others. The transcript is used to generate time-stamped events of interest, which are time-synchronized and used to generate time-stamped machine recording/processing instruction sets.

When the transcript is being processed, a set of recording/processing instructions are generated as a data object to increase recording resolution during these steps, and in some embodiments, the recording resolution is modified to hone in on particular types of sounds or activities corresponding to the sub-duration step. For example, during the faucet operation step as described earlier, during the first sub-duration step, the device can be configured to provide more focused recording resources into increase recording at a frequency between 4.5-5.5 kHz and in particular, high amplitude events in related spectral bands, identifying that there is a sound of running water.

Similarly, during the faucet operation step, a bounding box of pixels corresponding to a visual area being recorded by an overhead camera corresponding to the faucet may be recorded with a higher frame rate, subject to less compression, recorded with a different codec to improve the predictive and/or analytic capabilities of the cloud-based black box recorder controller 106 during downstream analysis.

A practitioner may use the practitioner's voice to provide exaggerated commentary in real-time as various steps are taking place, and the device can use the transcription to automatically generate time-stamped segments of each of the steps, and the transcription can be first utilized to generate the recording modification instructions before provisioning of the black box recording information for downstream processing by the cloud-based black box recorder controller 106, modifying how the raw black box recording are compressed and modified before transmission across a network to the backend cloud-based black box recorder controller 106. Similarly, during the steps, a practitioner may also orally indicate what tools or instruments were being used, what steps were being performed, whether modifications to the steps were required, and in addition to modifications to the recording, these steps can also be used to generate an activity or product use timeline for the purposes of improved recordation for billing or inventory tracking.

In some embodiments, the corresponding transcript and machine recording/processing instruction sets are appended into the electronic medical record data object of the patient, and the corresponding transcript and machine recording/processing instruction sets are utilized as an additional input signal into the cloud-based machine learning model in addition to the pre-processed recording that is transmitted through the network. Accordingly, transcription commentary such as “Black Box, focus on the next thirty seconds, the patient is exhibiting an abnormal response to anaesthesia” can be explicitly used to improve the prediction in addition to the modified or increased resolution during that period of time.

Similarly, the transcript may also be indicative of difficulties encountered by the practitioner during the procedure, such as encountering an expectedly large amount of fatty tissue obstructing a view into a portion of the liver, and in some embodiments, the augmented electronic medical record data object can be analyzed to modify or dynamically generate a post-operative care plan that has dynamic variables that can be modified based on processed outputs from the machine learning model or the transcript, or a combination of both.

The dynamic variables can include different steps that are instituted to manage different operative events, such as steps taken to monitor blood loss and recovery (e.g., hemoglobin treatment), infection (temperature), and these can be informed based on the transcript record. In some embodiments, the post-operative care practitioner and the surgical practitioner are different individuals, and this improved dynamic post-operative care can be used as a mechanism to provide an automatic level of contextual customization without requiring additional steps to be taken by a busy surgical practitioner to record more information and detail about the procedure.

The operating room 102A is a medical treatment facility room where procedures can be conducted. The operating room 102A is specially equipped to generate long-form raw audio/video recordings using the microphones 102. These can be configured to be turned on either based on triggered events (e.g., a booking of the operating room 102A), based on procedure timing, manually switched on/off, or in some embodiments, are always on unless otherwise switched off. Accordingly, the microphones 102 capture audio that may be several hours long, depending on the particular configuration. Determining when to snip and segment audio is an important consideration when there are large volumes of audio generated, especially across multiple sites having hundreds of rooms. This is a technical problem that needs to be addressed to yield an acceptable level of accuracy for a given amount of computing power.

A problem with operating room 102A is that the audio qualities and configuration is typically not known before implementation, and thus the system needs to be able to be handle a diverse set of spectral environments having different combinations of devices, individuals (each with their own speech patterns), who may or may not be speaking towards the direction of the microphone, etc.

As described herein, approaches for audio transcription are proposed and adapted for use to transcribe the audio from captured case recordings. Various transcription models are used to produce a transcript, and different models can be substituted or utilized.

A cloud based black box recorder controller 106 is a computer server or a set of connected distributed computing devices that are controlled to first conduct audio pre-processing using audio pre-processor 108, and the pre-processed audio is utilized with one or more neural networks (RNN 110 in this example) either for training or generation of transcripts. A transcription generator 112 sub-engine can be provided to generate output transcriptions based on the outputs of the one or more neural networks.

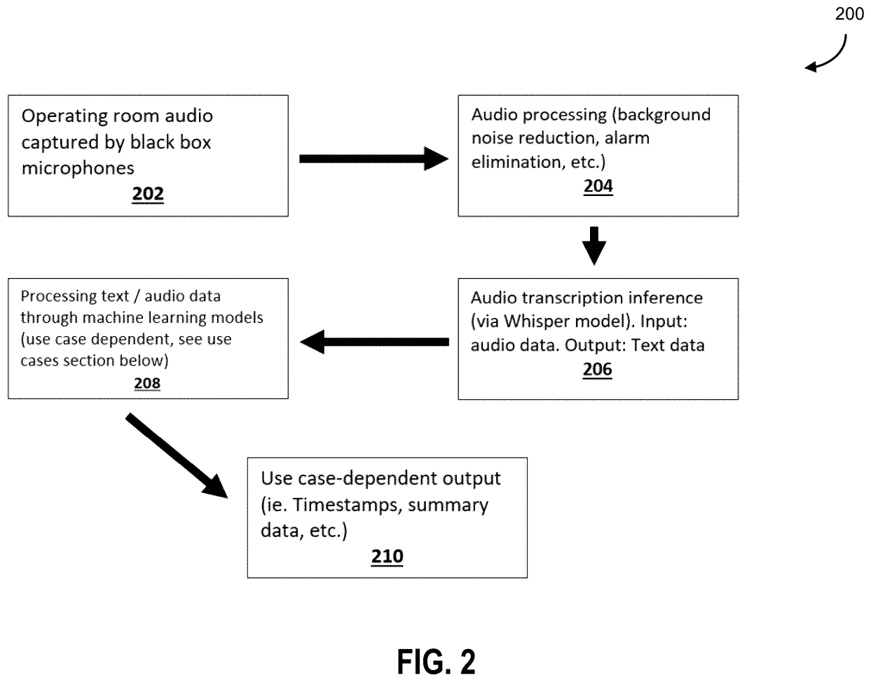

FIG. 2 is a process diagram showing an example method for computer prediction using voice and sound, according to some embodiments.

FIG. 2 illustrates a proposed workflow 200 that is described that where firstly, at 202, operating room audio is captured using one or more microphones, secondly, at 204, audio processing is conducted for, for example, background noise reduction, alarm elimination, etc.).

The workflow 200 can be used in conjunction with a dedicated local transcription engine 120, which is a specialized device including a computer processor that resides locally within the operating room 102A and is dedicated to generating transcriptions in real or near-real time (e.g., in 1-5 minute batches), generating transcription tokens representing audio artifacts, such as spoken commands, words used in conversations between practitioners, among others. As described above, dedicated local transcription engine 120 operates alongside a full suite black box recorder that is located within the operating room 102A that is configured for high quality recording by local OR recorder 104.

The high quality recording is recorded at a high bitrate/resolution with limited or no compression, and thus may not be suitable for transmission to a cloud based black box recorder controller 106, so the local transcription engine 120, operating in accordance with workflow 200, is used to modify how the high quality recording by local OR recorder 104 is processed before transmission to the cloud based black box recorder controller 106. This pre-processing transforms the high quality recording by local OR recorder 104 into practically useful variable quality recordings for improving machine learning accuracy while also preserving a useful level of compression for the transmission process. The variable quality is dynamically modified based on the intermediate output of the local transcription engine 120.

At 204, audio processing is an important step due to inconsistencies in sound environments. For example, specific technical challenges that can occur can include sound occlusions, such as the use of masks by practitioners, sound reflections, sound muffling, among others. Specific audio processing steps are required to address technical limitations of relating to model performance. For example, some machine learning models perform poorly on 3 hour videos, and intelligent approaches for clip sectioning and segmentation can be helpful to improve downstream performance (e.g., avoiding cutting in the middle of a sentence).

The raw audio is transcribed into text strings using a Whisper model (transformer-based), for example, configured at one-minute intervals. The text is cleaned using a SpaCy, a natural language processing library that is used for pre-processing, which includes removing stop words, punctuation, emojis, and repetitions, while preserving important negations (e.g., “not”, “no”). Words are lemmatized to their base forms to standardize the text for further processing. The cleaned text is processed in two-minute segments to classify timestamps into SSC categories such as briefing, timeout, and debriefing, and classification is conducted using a XGBoost, an optimized distributed gradient boosting library. Features used for classification include: a Bag of Words representation of the cleaned text, EMR-derived features, such as the segment's relative position in the procedure, and these features are input into the XGBoost model to predict SSC-related segments.

Specific audio processing approaches are utilized to address these problems in the input data, such as the use of the following mechanisms:

A first code module is configured to dynamically brightens higher frequency speech components by generating additional harmonics in the upper register. Various filter settings can be deployed and tweaked depending on specific requirements and impacts on overall accuracy. An example is the aexciter module, but it does not necessarily need to be this module and variations are possible.

A second code module can be used to normalize signal peaks to meet EBU R128 broadcast standards. An example is the loudnorm module, but it does not necessarily need to be this module and variations are possible.

Audio processing can also be used to “prime” the audio for improved performance for specific transcription use cases. For example, certain sections or segments of the audio may have certain computationally expensive tasks performed, such as automatic labelling, noise reduction, gain adjustment, etc. Due to the limited computing time available, in some embodiments, the approach includes a real or near-real time prioritization and triaging of sections for targeted audio processing.

In order to address the limitations described above with operating room speech, the system can be configured, in some embodiments, to process the audio files to utilize the following filters: 1) apply a filter to brighten higher frequency speech components by generating additional harmonics in the upper register, and 2) normalize signal peaks to meet EBU R128 broadcast standards. Both measures in tandem have the impact of increasing the clarity of speech and increasing the ability for our transcription models to capture the words spoken with greater accuracy.

With respect to running the filtered audio through our transcription models, a limitation of high quality transcription models is that since they leverage temporal and sequential relationships they have the ability to sway rather far away from the true transcription. For example, given that the previous words were “peanut butter and jelly”, it is increasingly probable that the next word will be “sandwich”.

While in short clips, this leads to improved performance, performance drops the longer the audio segment is. Since the system may be operating with audio that is most of the time more than two hours, techniques are proposed herein to intelligently cut the audio into multiple sections such that we mitigate this risk. However, with frequent audio cutting also comes compromised transcriptions in the sections immediately surrounding the audio cut, since the system could be cutting the audio mid word or mid-sentence. Hence, given an optimal segment length of 120 seconds, within each cut window (+−15 seconds of optimal), a first step is to identify the lowest volume point. Since volume is correlated with increased levels of speech, Applicants have observed that low volume sections point to sections with no speech or the least relevant. From there, the system is configured to run a transcription model and produce timestamped predictions.

Once processed audio is prepared, at 206, it can be used for transcription inference, where the input audio data is converted into textual data. Transcription inference includes generating the intermediate set of transcription tokens that are timestamped based on the timeframe upon which the token is uttered. In some embodiments, the starting point in time that a particular word or distinctive sound is made is used as the timestamp for that token, in other embodiments, the point in time may be a median time position.

At 208, specific use-case based models are then utilized for generating use-case dependent output, which can include specific data structures such as timestamps, summary data, etc. In some embodiments, specific use cases being used for transcription and classification have dedicated models for usage. A few use cases described herein include domain-specific use cases for checklist monitoring, instrumentation usage, as well as explicit instructions for having the recording at a higher level of quality during explicitly stated periods of time (e.g., a teaching hospital would like to have greater analytical depth during an experimental part of a surgical procedure step that has been modified to test a hypothesis proposed for greater patient safety or faster recovery).

The domain-specific use cases can also be adapted to use domain-specific trained transcription models, such as a model that is trained specifically to detect keyphrases for surgical safety checklists, another model trained specifically to detect keyphrases for instrument usage, and so on. For the surgical safety checklist example, the domain-specific trained model can be trained specifically using a training data set for the specific surgical safety checklist steps so that the classification capability of the domain-specific trained model can be enhanced, as certain words are commonly used even if there is a level of variability between the specific words being used by practitioners. Similarly, for the instrument/product tracking example, the domain-specific trained model can be trained specifically using a training data set for instrument names and variations thereof (e.g., no. 3 scalpel, no. 4 scalpel). A benefit of training with domain-specific training sets for each domain-specific trained model is that confounder words, for example, such as scalpel (there are many types of scalpel) can have less emphasis or need to be combined together with the type to distinguish between the different types.

In an applied, non-limiting example, all of the domain-specific trained transcription models are based on a specific baseline Whisper based machine learning model architecture for domain-general capability, which is then forked in multiple instances for domain-specific fine tuning for use case specific jargon. Training sets can be obtained from previous recordings or generated training examples, and tuned over time as additional examples become available.

At step 210, each of the domain-specific trained transcription models are utilized to generate the transcription outputs for their specific domain-specific track. The transcription outputs are time-stamped words or token artifacts associated with a corresponding transcription track. These transcription outputs can be provided in the form of tuples (word, timestamp, confidence), and are used as intermediate outputs. The intermediate transcription outputs are then processed to regenerate a data object corresponding to periods of time and associated steps and sub-steps of a corresponding data object of steps that are matched to specific transcription words/tokens.

In some embodiments, the corresponding data object of steps includes pre-processing instructions that are tuned to improve the performance of a backend machine learning model by changing how the local operating room recorder 104 generates a pre-processed version of the recording for transmission to the cloud based black box recorder controller 106. For example, the data object can include that for certain hand washing steps, bitrate is increased for audio at particular frequencies (to track whether water was flowing from the faucet as a proxy to assess whether the hands were washed properly and how long), while for other steps, bitrate can be increased for video or for certain portions of the video (e.g., rubbing of the hands with soap may increase resolution in a bounding box area directed to the hands over the sink).

By dynamically generating selective instructions for only limited resolution increase/compression reduction, limited computing and networking resources can be conserved, which allows the solution to be practically feasible in multi-site hospital environments, which may be computationally restricted due to the need to use existing computational capabilities and networking rails (e.g., outdated CAT5 cabling, poor signal environments for transfer over WiFi), etc.

The proposed approach as illustrated at workflow 200 is directed to converting raw audio data into meaningful insights. The different use cases can include, for example, surgical safety checklist timing prediction, additional time-stamping (e.g., start of intubation, time of blood transfusion), case summary notes (which could then be directly inserted into the EMR (i.e., “3 blood transfusions, surgeon indicated to keep in ICU 5 days, etc.), and speech initiated commands that are triggered based on defined specific audio commands that result in downstream action (e.g., “BLACK BOX . . . FLAG this case”, “BLACK BOX . . . CLIP the next 30 seconds in Explorer”).

For example, in respect to checklists, there exists a collection of words relatively unique to when the checklists take place (e.g., “Timeout”, “Briefing”, etc.), and initial results are suggesting that these relationships are well within the limitations of RNN-based architectures.

Specifically, the system is adapted to practically implement this use-case and other timestamping use-cases with the following proposed methodology: Given the transcription data for a given surgical case, harness machine learning models to predict event timestamps entails first transforming the transcription text into numerical forms, potentially using techniques such as Word Embeddings or Transformer-based models, but not limited specifically to these models.

Recurrent Neural Networks (RNNs) or Transformer models can serve as suitable choices for capturing the temporal relationships in the data. Specifically in a proposed embodiments, RNNs are configured to capture and learn the temporal relationships associated with surgical safety checklists and other output variables.

Employing an encoder-decoder architecture, the encoder processes the numerical transcription data, and the decoder generates predicted timestamps based on the encoded data. Through training on paired input-output sequences, using a relevant loss function and techniques like teacher forcing, the model predicts event timestamps accurately.

With respect to speech-initiated commands, this will involve the identification of trigger phrases (also called wake words). Given a set of pre-identified commands, audio segments are extracted and processed using features like MFCCs or spectrograms, and the pre-trained transcription model is employed to determine whether the trigger phrase is present.

By setting a confidence threshold, the decides when the trigger phrase has been detected with sufficient certainty. To prevent false positives, the approach can also be adapted, in some embodiments, to employ techniques such as contextual analysis. Over large labelled datasets, there have been have identified phrases and words that are increasingly probable to surround a user command.

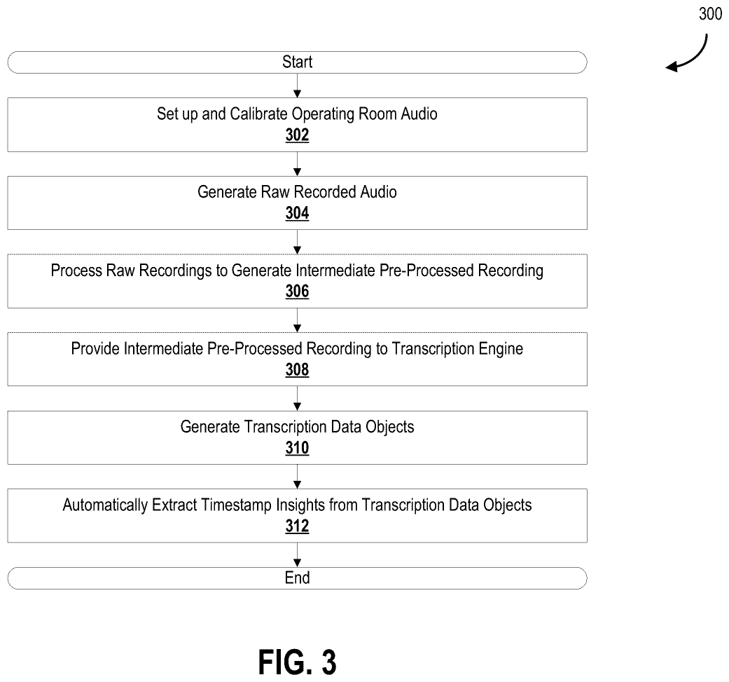

FIG. 3 is a process diagram showing an example method for use-case specific transcript/audio processing for checklist timing prediction, according to some embodiments.

At 302, an operating room is set up for recording room audio. This can include steps of calibrating recording devices and/or conducting testing, for example to determine parameters for adjustment and provisioning to downstream recording configurations or as an input into machine learning steps. This is particularly useful in noisy environments or in environments with poor echo-acoustic properties. In some embodiments, practitioners can be asked to speak in garment setups similar to those in use during the procedure itself, so that sound coming through masks (e.g., which could be otherwise garbled).

At 304, raw recorded audio is generated, which can include arbitrarily long audio recordings, such as all recordings generated over a 12 hour span that the operating room is in use.

At 306, the raw recorded audio is processed, and this can include automatically determining break points for portioning the audio for downstream analysis, acoustic shaping approaches, among others. An intermediate pre-processed recording is generated. This can be used, for example, to help de-identify participants as well, as desired. These approaches can be used in conjunction with the machine learning steps in some embodiments to automatically tune shaping parameters or snipping parameters in an attempt to improve the overall quality of transcription tokens being generated by the approach.

At 308, the intermediate pre-processed recording is provided to a transcription engine, such as a neural network. The intermediate pre-processed recording can be converted into a series of input vectors, broken into individual tokens, and the neural network is configured to generate transcription tokens corresponding to various utterances at 310.

At 310, the transcription tokens can include various words or event sounds that have been spoken by various individuals in the room (e.g., instructions by the surgeon) or made by various machines present in the room (e.g., heartbeat sounds), or sounds relating to a particular event (e.g., the sound of an orthopedic event occurring on a bone).

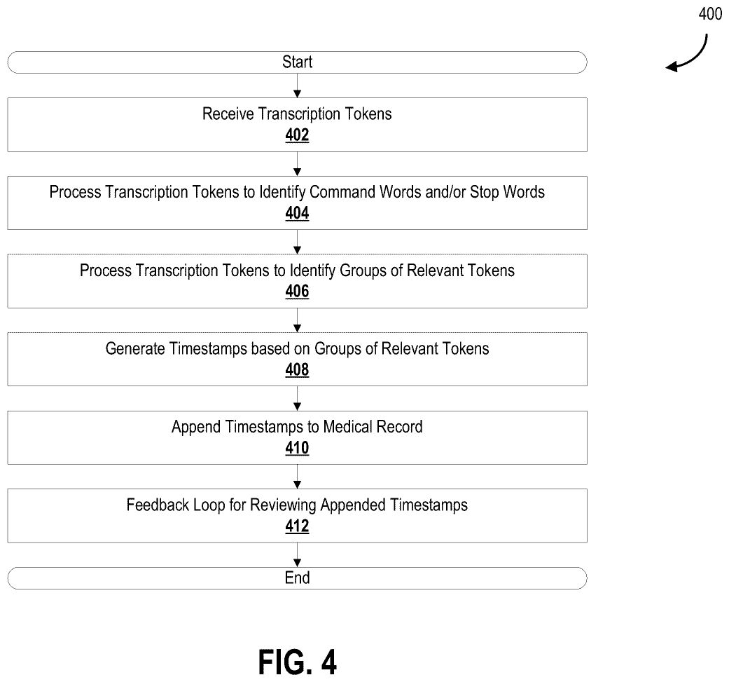

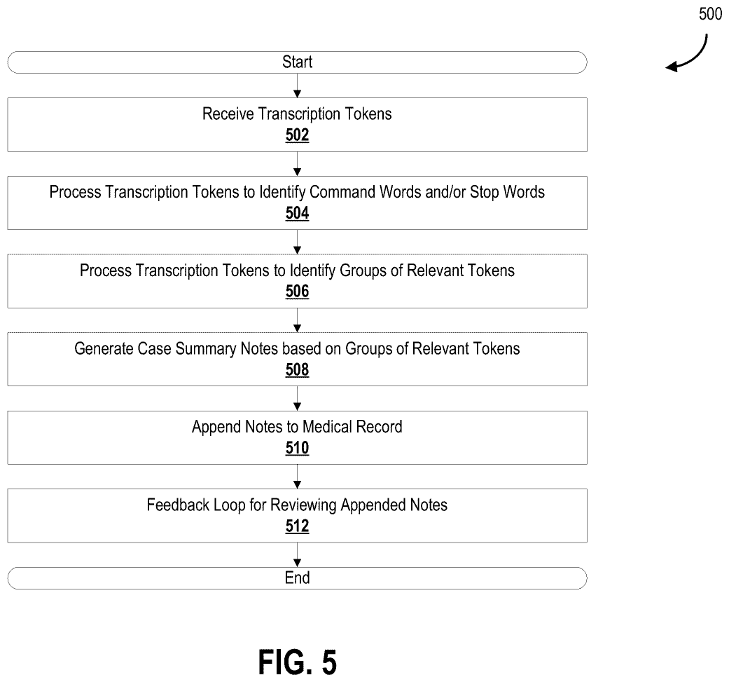

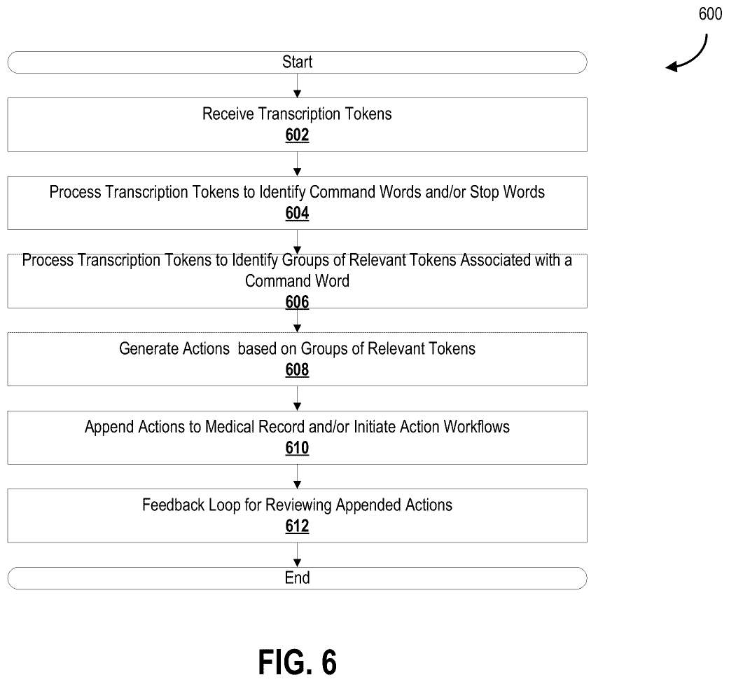

At 312, in some embodiments, the transcription tokens can be extended with timestamp data fields to generate timestamped transcription tokens, and these can be used for downstream processing or conducting various activities, as shown in FIG. 4, FIG. 5 and FIG. 6. The output can simply be the tokens themselves, which can be appended onto a health medical record, for example, in addition to surgeon's notes, for example. This can be helpful to reduce the overall administrative tasks required.

Once the time-stamped transcription tokens are generated, they are utilized to determine when various steps of the checklist have taken place, and can be used to augment a checklist-specific data structure by filling in fields relating to estimated timestamps for when various steps start/end, and the confidence related thereof of the determination. This can be based on a classification based on specific transcription words being tracked. The words can include explicit words or phrases, such as “Black Box, I am turning on the faucet”, or “Black Box, I am starting Step 1 of the hand washing checklist”, and so on.

Each step is then associated with a start/stop timestamp, and the tracked timestamps can then be used to modify compression/resolution/bitrate when generating the final version of the recording to be transmitted to the cloud backend for machine learning-based analysis. In some embodiments, the specific time-stamped timeframe/data structure is also transmitted as part of a package, and the cloud backend's machine learning model includes input activation layers that receive as inputs at least the time-stamped timeframe/data structure, and the generated pre-processed output from local operating room recorder 104 that has been dynamically pre-processed with variable compression and transformation.

In the instrument/inventory tracking example, instead of specific steps, each of the inventory items or activity steps being used or done instead is established with a specific timestamp relating to when it was done, and instead of having a data structure with steps that have times that are filled in, the data structure is dynamically generated with each inventory item being used and the timestamp at when it was used. The modification instructions are configured to modify/increase recording resolution/intensity for a time period around the inventory item being used or action being taken so that it can be analyzed and confirmed for inventory or reimbursement purposes. The modification instructions may change from item type or service type, and can be obtained from a lookup table or reference data structure.

For example, for different types of scalpels being used, the modification instruction can include increasing resolution around two bounding boxes, a first for the instrument tray, and the second for the practitioner's hands so that it can be confirmed by the downstream analysis of the recording by cloud based black box recorder controller 106 that the correct item was used. In this example, the two bounding boxes, when the practitioner says “no. 4 scalpel” are recorded at a higher intensity for a period of time from tₑᵥₑₙₜ−1000 ms to tₑᵥₑₙₜ+1500 ms. This allows the backend system to verify through machine learning, that the support staff put the right scalpel on the instrument tray, and it was picked up and used by the practitioner.

On a high confidence score that the instrument was used (e.g., no. 4 scalpel) or a particular activity occurred (e.g., sutures or surgical staples), inventory records corresponding to the particular procedure can be updated for reimbursement purposes, recall purposes, or for updating an electronic medical record. These can also be used to verify the electronic medical record in an audit, for example. The outputs can be used for controlling resupply operations, sanitation operations, or tracking the level of inventory usage by different practitioners. Similarly, it can also be tracked against post-operative outcomes for modification of post-operative plans, as using different tools may lead to different recovery times and steps (e.g., surgical staples vs. sutures vs. liquid stitches), and may also have different care steps (e.g., when a person can take a shower or get the injury area wet).

In some embodiments, a feedback loop is provided to assess the quality of the transcription tokens, including, for example, a potential coherence score if all of the tokens are taken into consideration together. This can be conducted by an additional neural network that is used as a critic of the output of the transcription neural network. If the coherence score is below a defined threshold, for example, in some embodiments, the system is configured to automatically perturb the intermediate generation controls to re-generate intermediate recordings from the raw recordings, and to run the transcription token extraction process again. Multiple variations are possible where parallel perturbations can be run at the same time or around the same time to increase the odds of a useful transcription to be generated. When a useful transcription is generated, in some embodiments, those specific perturbed parameters are set as the default for a particular operating room or location.

FIG. 4 is a process diagram showing an example method for use-case specific transcript/audio processing for enhanced time-stamp generation, according to some embodiments. In this example, the tokens are also used to append additional case summary notes that serve as an additional signal for machine learning by the cloud based black box recorder controller 106. These can be used in addition to a post-operative summary, and rather represent a contemporaneous record of the conversation and potential sound artifacts during, before, or after the procedure.

As these outputs are generated as part of the dynamic control steps of the generation of the pre-processed recording for transmission to the cloud based black box recorder controller 106, they can be appended to the electronic medical record, for example, as an additional data object or a set of data fields provided as part of a package of files in the electronic medical record such that they can be included as part of the dimensional features for downstream machine learning. As the downstream machine learning models in the cloud based black box recorder controller 106 are utilized to generate various insights or machine learning model based predictive outputs, the transcript tokens can be used as an additional input signal.

For example, if the cloud based black box recorder controller 106 is being used to generate a predictive output of whether a patient may have a higher risk of infection and thus the post-operative care plan needs to reflect that, the voice transcript that the appendix may have partially burst is a useful signal and can also be cross-verified by the cloud based black box recorder controller 106 using the specific generated recording with additional emphasis around the timestamp when that was recorded. For this type of procedure (appendectomy), complications can occur depending on how the appendix presents after the practitioner explores the abdomen, and the locally generated transcript generated by transcription engine 120 provides a useful signal to track these complications.

At 402, transcription tokens can be received from the transcription neural network for time-stamp generation.

At 404, the transcription tokens are processed to identify specific command words or stop words.

At 406, groupings of relevant tokens can be generated using, for example, clustering approaches, to identify specific groupings for specific time periods.

At 408, the groups of relevant tokens can be associated with a particular time-stamp or predicted event.

At 410, the specific timestamped events and their durations can be appended to an electronic health record to provide additional resolution for downstream analysis.

At 412, the timestamped events and durations can be evaluated, for example, by a human reviewer to assess whether the automatically generated groups accurately reflect time periods of certain events occurring in the surgical theatre. These outputs can be provided in a feedback loop, and in some embodiments, the transcription tokens can be either re-generated from the raw audio or the processing of transcription tokens can be re-run with perturbed generation parameters.

FIG. 5 is a process diagram showing an example method for use-case specific transcript/audio processing for case summary additions, according to some embodiments.

Similar to FIG. 4, at 504, the groups of transcription tokens are instead utilized to generate automated summary event notes based on the identified groups. These notes are appended to the medical record at 510, and a feedback loop for reviewing appended notes is provided at 512. This can be used to generate automatically established notes files, which are useful as it can avoid or augment a human process where nurses or doctors would typically hand write notes for placement into the file. These automatically generated notes can also be put on file and used to assist human recollection, etc.

FIG. 6 is a process diagram showing an example method for use-case specific transcript/audio processing for speech initiated commands, according to some embodiments.

Similar to FIG. 4, at 606, instead of generating timestamps, specific blocks of tokens can be associated with a particular command from a practitioner. The commands can include commands such as noting a particular section of the audio recording as of increased importance, asking that a particular note should be taken, asking that a particular machine's input should be tracked for a particular duration, among others. For example, a surgeon may say that a certain recording portion should be reviewed (e.g., by another specialist surgeon) or is exemplary (e.g., for training purposes). At 608, these generated word commands can then be coupled with action outputs that can cause specific control of downstream devices. These action outputs can be automatically generated computer process invocation of downstream functionality.

These action outputs can have different types, such as action outputs that are automatically executed whenever they are identified first, and run once, such as a surgeon asking for a room to be sanitized due to an event causing a loss of sterility.

Another type of action output can be a synchronized timestamp feature that can be run whenever a reviewer or downstream program is reviewing the transcript, the raw audio or an intermediate processed audio. For example, the action may be to cause a specific graphic or alert effect for a particular duration of the surgery. Similar to the appended notes, a feedback loop is also possible to review appended actions for accuracy, and the feedback can be used to tune future generated similar actions.

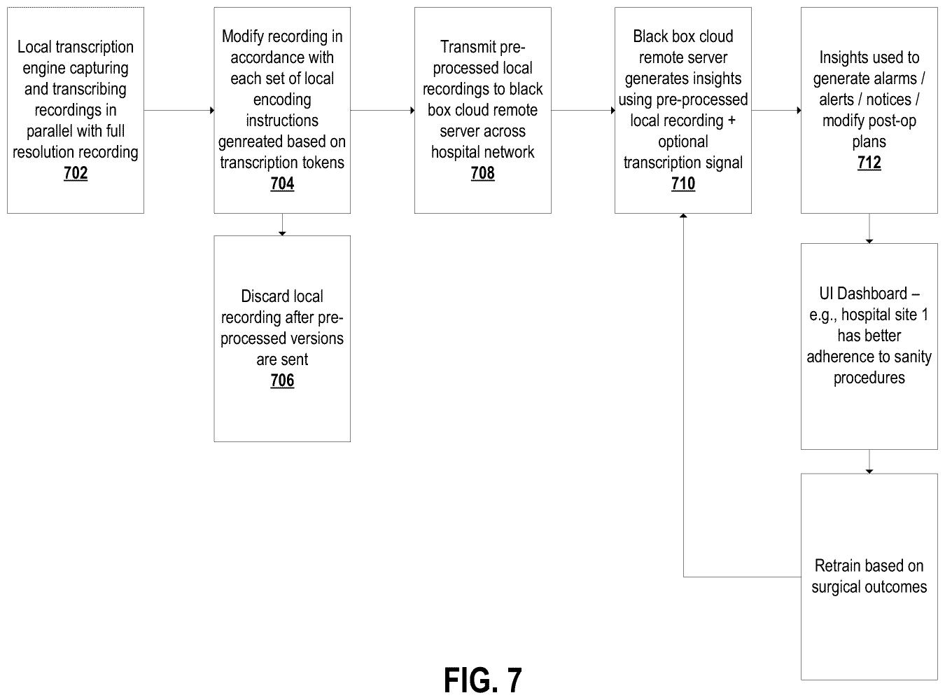

FIG. 7 provides an example pipeline flow for a practical applied implementation for an example hospital network having multiple hospital sites each having multiple operating rooms that are coupled to one or more instances of cloud based black box recorder controllers that are adapted to receive pre-processed recordings and generate machine learning predictive outputs by processing the pre-processed recordings along with other input signals against trained models, according to some embodiments. As described herein in process flow 700, the hospital network has limited networking and computing resources, and compression and pre-processing is required at the local operating room 102A level before transmission and machine learning is conducted by the cloud based black box recorder controller 106, which serves as a centralized processing instance for the entire hospital network.

At step 702, the local transcription engine 120 captures and transcribes recordings in parallel to each of the full recordings generated locally by the recording components of the local operating room recorder 104 before, during, or after a procedure. As described earlier in various examples, raw transcription text tokens, corresponding timestamps are generated as an intermediate output of step 702. These are then coupled to use-case specific data structures to create events and time-durations related to individual steps or sub-steps. In some examples, the steps are provided in a template data structure (e.g., for a checklist set of steps), while in other embodiments, the data structure is dynamically generated with a row for each specific action or item detected in the transcription (e.g., for inventory tracking). Each of these use-case specific data structures are then used to generate modification instructions to pre-process the full recordings generated locally by the recording components of the local operating room recorder 104 to control how they are compressed and transformed (e.g., truncations, different codecs applied, different resolutions).

Essentially, the modification instructions are used to preserve certain aspects of the original quality level of the recording to prevent the compression process from removing useful information elements that are used for downstream machine learning. Compression is practically necessary to have the system operate in a viable manner given practical limitations on computing resources, but over compression yields an unacceptable loss of predictive capability by the backend machine learning models. At 704, once the modifications have been completed in accordance with the local compression instructions, at 706, the local recording can optionally be scheduled or slated for discarding in accordance with a local retention policy to provide additional space for future recordings. As local storage may be more readily available, for example, the local storage may be a 10 TB recording loop that simply overwrites the oldest recordings when capacity is reached, and so forth. The local storage recording need not discard the recordings immediately, in some variant embodiments, pre-processed versions are generated based on scheduled availability and may occur asynchronously depending on the particular use case. For example, the pre-processed recording stream for usage for machine learning based determination of adherence to a checklist may be prioritized for immediate generation, while the pre-processed recording stream for usage for inventory tracking may occur at an opportunistic time when computing or networking resources are comparatively more free as it is less time sensitive. These can occur in batches overnight, for example, for an overnight inventory reconciliation.

The pre-processed recordings are transmitted across the network periodically at 708 to the cloud based black box recorder controller 106, optionally along with the timestamped transcription tokens and/or the timestamped domain specific data structure for generation of predictive insights. As the pre-processed recordings have selective dynamic compression, compression approaches can be more readily used without inadvertently reducing the capability of the machine learning model to generate useful insights.

At 710, the cloud based black box recorder controller 106 is configured to generate predictive insights using the pre-processed recordings, and different variations are possible, such as hospital-network wide predictive insights, or operating room/practitioner specific insights, such as measuring and tracking adherence to surgical checklists, tracking inventory usage, generating future state recommendations based on comparisons of multiple similar surgeries for automatic estimation of leading practices based on a loss function optimized to reduce a propensity of post operative complications.

The pre-processed recordings can also be used to dynamically modify post-operative recovery plans by selecting post-operative recovery options based on confidence scores generated from the pre-processed recordings, for example, based on whether the patient has a higher machine predicted likelihood of infection. In this example, the patient with the higher machine predicted likelihood of infection is recommended or automatically scheduled to have a tighter follow up schedule to ensure that the infection can be contained, if it does arise. A tailored post-operative recovery plan that is automatically tailored based on machine learning based outputs is particularly useful as busy practitioners have little available time and may not have captured all of the pertinent details in the post operative notes. Similarly, a benefit of using machine learning models in the backend is that environmental or other signals can be captured, such as a humidity or temperature in the operating room during the procedure, which may be relevant to the spread of infection causing bacteria.

At 712, the outputs can also be used as inputs for rendering a black box dashboard user interface for generating alerts or notifications based on global, operating room, or individual level pre-defined thresholds are met from the machine learning predictive outputs. For example, a machine learning process may be invoked for every surgical procedure to ensure that proper sanitation steps were taken, and different thresholds can be used for alert generation.

In this example, a high criticality alert can be issued in real or near real-time after the procedure if the checklist was not started at all or if there has been an extremely low score with high confidence generated for the execution of the checklist. However, for weak adherence to particular steps or unclear adherence, in some embodiments, the outputs are aggregated to generate overall recommendations (at hospital site 2, practitioners are not washing their hands for a sufficient period of time) or insights on a dashboard for a particular institution, so that individual practitioners, groups of practitioners (if de-identified), or hospital sites can be compared based on the processed recordings. The dashboard, in some embodiments, can include analytics/rankings, while in other embodiments, can include specific suggestions for remediation or further correlations with post-operative outcomes if the corpus of procedures being analyzed is sufficiently large.

FIG. 8 is an illustration showing a pictorial representation of the pre-processing instructions to be applied to the full resolution local recording, according to some embodiments. In the example pictorial 800, a set of instructions pre-processing instructions are shown in timeline format. In practical implementation, the instructions will be provided in a structured data object having time period durations embedded therein and corresponding compression/video generation/transformation instructions that can be used in a conversion pipeline process to generate the pre-processed media stream/package to be sent across the network for backend machine learning.

In this example, a two hour procedure has been recorded by the main recorder cameras, microphones, and other device APIs and couplings to generate a large, full resolution recording file 802 (4320 GB), which is a set of 4 4K feeds at 30 frames per second from four different cameras. This recording file 802 is too large to practically send over the network or analyze as the hospital network has a hundred operating rooms across two different hospital network sites. Accordingly, the recording file needs to be pre-processed first to generate the compressed feed 804. As described above, there can be multiple parallel pre-processed versions generated from a single full recording, in variant embodiments.

In this example, a transcription of audio and the timestamped tokens are generated, and then a data structure with timeframe sections is populated or instantiated, depending on the use case. This data structure can include Section N, tₛₜₐᵣₜ, tₛₜₒₚ, and stringActivityType. The stringActivityType can then be compared against a reference dataset to identify the type of recording features that need be preserved for improved analysis. The reference dataset can, for example, be a reference data object that is used for a lookup.

In the example shown in 800, a handwashing checklist is shown. At 806, an example illustration is shown to indicate that there are only certain periods of time which were associated with the handwashing checklist. For this particular pre-processed feed that is designed to focus on improving accuracy and checking adherence with the handwashing checklist, the non-relevant times may be designated with default recording/compression characteristics for processing, such as converting to low-resolution, low frame rate, low bit rate, reduced color maps, etc. In another variation, the non-relevant times are simply removed from the recording.

The data structure in this example is pre-populated with steps from a reference template data structure adapted for the handwashing checklist, and in this example, there are 6 steps to the handwashing checklist. The different timeslots are identified for each step based on tokens identified within the transcription, such as the practitioner saying “Step 1”, “Step 2”, and so forth.

Each step has different characteristics, such as turning on a faucet, activating a soap dispenser, scrubbing hands, washing elbows, drying hands, etc. These are shown in expanded timeframe 808. To track adherence and measure the quality of the activities taken at each step, the backend machine learning model will benefit from different recording characteristics at each of the steps, and in this example, Step 1 has a faucet activation. During Step 1, the data structure is prepopulated that the audio is required to maintain a high bitrate and high resolution (with low compression) so that the audio can be preserved at a higher quality level relative to the baseline to be able to detect the sound of running water, indicating that the faucet was turned on. However, Step 2 includes operating a soap dispenser, and for the purposes of this example, the soap dispenser is relatively silent, so instead, the video feeds (or a corresponding bounding region associated with the soap dispenser) are maintained at full resolution without compression (or a lower level of compression). The data structure can include a high level of granularity in respect of control parameters in some embodiments, while in other embodiments, the control parameters can be quantized (e.g., Step 1, stringAudioQuality=HIGH, stringVideoQuality=LOW). In the example shown in 800, Steps 1 and 6 have similar control parameters, while Steps 2-4 and Step 5 have different control parameters, respectively. More granular parameters for each step, in addition to stringAudioQuality or string VideoQuality may also be specific frequencies or screen portions to be emphasized in high quality, such as stringAudioQualityl5 kHz=HIGH, stringVideoQualityInstrumentTray=HIGH, among others. These more granular parameters

These features are used by a converter/encoder as input parameters to control how the conversion/encoding is conducted as part of the generation of the pre-processed feed/stream to be provided to the cloud controller 106. Using the enhanced video, cloud controller 106 is more capable in generating machine learning outputs indicative of whether steps were adhered to, and the quality of the adherence to the individual steps (e.g., whether the machine learning model was able to predict that the step took place, and how high quality the step was relative to a baseline generated from the reference training set for the particular step). For example, an example output may be (Step 1, booleanActioned=Yes, floatQualityScore=0.3), indicative that the practitioner may have rushed this step. These outputs can be consolidated across an entire hospital site, for example, and tracked against post-operative care complications, such as MRSA infection rates, etc., and used to generate performance metrics or leading practices. Each hospital site can render a safety quality dashboard that is indicative of how the machine learning model rated the conformity level and quality to the particular safety checklists.

Similar to 800, another variation of the checklist can include a surgical safety checklist that includes a verbal checklist conducted by a surgeon before different time segments of a procedure. This can include, for example, steps taken before induction of anaesthesia, steps taken before skin incision, and finally before a patient leaves an operating room. These steps are designed to avoid catastrophic errors, for example, wrong site surgery, giving allergic medication while a person is under anaesthetic, among others. In this version of the checklist, the various steps are broken into sub-steps for different step.

In the first step, the time period is identified as before the induction of anaesthesia, and includes steps of verbally confirming that the patient has confirmed identity, consent, site, procedure, noting that the site is marked, that the anesthesia machine and medication checks are complete, that the pulse oximeter is on the patient and functioning, and checks relating to allergies, airway/respiratory risk, and blood loss risk.

Before skin incision, all teams are required to verbally state their name and role, and the patient can be asked to verbally confirm the patient's name, procedure, and where the incision will be made. The team verbally confirms whether antibiotic prophylaxis has been given in 60 minutes, and each of the surgical team can also describe any anticipated critical events, such as confirming that sterility of the surgical field has been confirmed, whether there are equipment issues, among others.

Finally, before leaving an operating room, the surgical team can confirm the name of the procedure, completion of the instrument, sponge, and needle counts, specimen labelling (reading the specimen labels aloud including the patient's name), and whether there are any equipment problems to be addressed. In this example, if a specimen is extracted (e.g., in a biopsy example), an additional verbal checklist may be performed relating to avoiding contamination, and then storage, labelling, tracking. Using the transcription based approach proposed herein adapted based on a combination of voice and sound to control recording stack operation and/or compression thereof is proposed to aid greatly in the accuracy of specimen handling and management, and the avoidance of manual error.

As described herein, a number of embodiments have been proposed that utilize an innovative combination of obtained voice and sound transcription artifacts to monitor adherence to operating procedures such as surgical safety checklists, specimen checklists, instrument/procedure tracking, among others. While simplified examples have been described, it is important to note that each procedure may vary, and there are more complicated examples where there can multiple operating protocols that are implemented for a particular procedure, and verbal protocols may vary from hospital to hospital or from network to network based on different site specific considerations and specialities. For the billing use case example, each of the verbal communications for the purposes of improving the machine learning through controlling the black box recording cloud parameters is particularly useful in reconfirming that the correct instrument was being used by cross-validating against surgical recordings of the instrument tray in video, for example, so that enhanced accuracy in billing and inventory tracking is possible. The transcript and the corresponding video/audio outputs can be used to cross-validate what instruments, sponges, implantable devices were used (e.g., hernia mesh), and what additional or variations on the steps were performed (e.g., practitioner opportunistically corrected a minor hernia while removing gallbladder based on prior instruction from the patient to fix anything identified during the procedure). The corresponding video/audio outputs can be used, for example, by an insurance company, to cross-verify that the particular procedure associated with a particular billing code was completed.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

What is claimed is:

1. A system for generating timestamped transcriptions using a local audio machine learning model data architecture to control compression parameters for converting local video recording data captured in an operating room or therapeutic facility prior to transmission to a remote machine learning controller configured to process the converted recording data using a trained machine learning model data architecture, the system comprising:
a computer memory;
non-transitory computer readable storage media;
a processor configured to:
record one or more raw audio data recordings in or proximate to the operating room or the therapeutic facility;
conduct initial pre-processing against the one or more raw audio data recordings using the local audio machine learning model data architecture to transform the one or more raw audio data recordings into a set of intermediate pre-processing recording audio token data objects representative of time-stamped words or phrases;
using machine classification, cluster the set of intermediate pre-processing recording audio token data objects to establish timestamped durations of time, each duration of time corresponding to a data entry having a field type in a data structure;
generate a media conversion instruction set data object including encoder parameter instructions for encoding the local video recording data, the encoder parameter instructions dynamically modified based on the field type corresponding to each duration of time for each data entry in the data structure, the encoder parameter instructions adapted to selectively maintain fidelity from the local video recording data;
encode the local video recording data based at least on the media conversion instruction set data object to compress the local video recording data; and
transmit the encoded recording data across a network to the remote machine learning controller, the remote machine learning controller configured to process the encoded recording data using the trained machine learning model data architecture.

2. The system of claim 1, wherein the local audio machine learning model data architecture is a trained domain specific audio machine learning model data architecture trained using data sets corresponding to the data structure.

3. The system of claim 1, wherein the data structure includes data entries that correspond to specific steps of a surgical safety checklist, and each of the specific steps and the corresponding data entries include specific encoder parameter instructions adapted to require reduced compression of at least one of audio and video during the corresponding duration of time.

4. The system of claim 3, wherein the required reduced compression is established through using variable compression mechanisms the during encoding of the local video recording data.

5. The system of claim 4, wherein the required reduced compression is established through using variable bit-rate compression the during encoding of the local video recording data.

6. The system of claim 1, wherein the data structure is dynamically generated based on transcription tokens indicative of specific surgical instruments being used or procedures being conducted, and each of the data entries are dynamically associated with a period of time proximate to the timestamp of the transcription token indicative of specific surgical instruments being used or procedures being conducted.

7. The system of claim 6, wherein each of the specific surgical instruments being used or procedures being conducted are used for comparison against a reference data structure to establish then specific encoder parameter instructions adapted to require reduced compression of at least one of audio and video during the corresponding duration of time.

8. The system of claim 1, wherein durations of time in the local video recording data that are not associated with a duration of time in the media conversion instruction set data object are not encoded in the encoded recording data.

9. The system of claim 1, wherein the local audio machine learning model data architecture operates on local computing infrastructure of the operating room or therapeutic facility and is configured for separate computing operation from electronic recorders capturing the local video recording data.

10. The system of claim 9, wherein the remote machine learning controller is electronically coupled across a plurality of network connections, each network connection coupled to an operating room or therapeutic facility of a plurality operating rooms or therapeutic facilities, the plurality of network connections having a limited amount of network bandwidth, and wherein the encoding based at least on the media conversion instruction set data object compresses the local video recording data before transmission to conserve network bandwidth across the plurality of network connections.

11. A method for generating timestamped transcriptions using a local audio machine learning model data architecture to control compression parameters for converting local video recording data captured in an operating room or therapeutic facility prior to transmission to a remote machine learning controller configured to process the converted recording data using a trained machine learning model data architecture, the method comprising:
recording one or more raw audio data recordings in or proximate to the operating room or the therapeutic facility;
conducting initial pre-processing against the one or more raw audio data recordings using the local audio machine learning model data architecture to transform the one or more raw audio data recordings into a set of intermediate pre-processing recording audio token data objects representative of time-stamped words or phrases;
using machine classification, clustering the set of intermediate pre-processing recording audio token data objects to establish timestamped durations of time, each duration of time corresponding to a data entry having a field type in a data structure;
generating a media conversion instruction set data object including encoder parameter instructions for encoding the local video recording data, the encoder parameter instructions dynamically modified based on the field type corresponding to each duration of time for each data entry in the data structure, the encoder parameter instructions adapted to selectively maintain fidelity from the local video recording data;
encoding the local video recording data based at least on the media conversion instruction set data object to compress the local video recording data; and
transmitting the encoded recording data across a network to the remote machine learning controller, the remote machine learning controller configured to process the encoded recording data using the trained machine learning model data architecture.

12. The method of claim 11, wherein the local audio machine learning model data architecture is a trained domain specific audio machine learning model data architecture trained using data sets corresponding to the data structure.

13. The method of claim 11, wherein the data structure includes data entries that correspond to specific steps of a surgical safety checklist, and each of the specific steps and the corresponding data entries include specific encoder parameter instructions adapted to require reduced compression of at least one of audio and video during the corresponding duration of time.

14. The method of claim 13, wherein the required reduced compression is established through using variable compression mechanisms the during encoding of the local video recording data.

15. The method of claim 14, wherein the required reduced compression is established through using variable bit-rate compression the during encoding of the local video recording data.

16. The method of claim 11, wherein the data structure is dynamically generated based on transcription tokens indicative of specific surgical instruments being used or procedures being conducted, and each of the data entries are dynamically associated with a period of time proximate to the timestamp of the transcription token indicative of specific surgical instruments being used or procedures being conducted.

17. The method of claim 16, wherein each of the specific surgical instruments being used or procedures being conducted are used for comparison against a reference data structure to establish then specific encoder parameter instructions adapted to require reduced compression of at least one of audio and video during the corresponding duration of time.

18. The method of claim 11, wherein durations of time in the local video recording data that are not associated with a duration of time in the media conversion instruction set data object are not encoded in the encoded recording data.

19. The method of claim 11, wherein the local audio machine learning model data architecture operates on local computing infrastructure of the operating room or therapeutic facility and is configured for separate computing operation from electronic recorders capturing the local video recording data.

20. A non-transitory computer readable medium, storing machine interpretable instruction sets, which when executed by a computer processor, cause the computer processor to perform steps of a method for generating timestamped transcriptions using a local audio machine learning model data architecture to control compression parameters for converting local video recording data captured in an operating room or therapeutic facility prior to transmission to a remote machine learning controller configured to process the converted recording data using a trained machine learning model data architecture, the method comprising:
recording one or more raw audio data recordings in or proximate to the operating room or the therapeutic facility;
conducting initial pre-processing against the one or more raw audio data recordings using the local audio machine learning model data architecture to transform the one or more raw audio data recordings into a set of intermediate pre-processing recording audio token data objects representative of time-stamped words or phrases;
using machine classification, clustering the set of intermediate pre-processing recording audio token data objects to establish timestamped durations of time, each duration of time corresponding to a data entry having a field type in a data structure;
generating a media conversion instruction set data object including encoder parameter instructions for encoding the local video recording data, the encoder parameter instructions dynamically modified based on the field type corresponding to each duration of time for each data entry in the data structure, the encoder parameter instructions adapted to selectively maintain fidelity from the local video recording data;
encoding the local video recording data based at least on the media conversion instruction set data object to compress the local video recording data; and
transmitting the encoded recording data across a network to the remote machine learning controller, the remote machine learning controller configured to process the encoded recording data using the trained machine learning model data architecture.
